(19) United States
(12) Patent Application Publication
(10) Pub. No.: US 2021/0224830 A1
(43) Pub. Date: Jul. 22, 2021

(54) System and method for calculating and benchmarking an entity's overtourism score

(71) Applicant: Esha Sanjay Thorat, Charlotte, NC (US)

(72) Inventor: Esha Sanjay Thorat, Charlotte, NC (US)

(21) Appl. No.: 17/106,914

(22) Filed: Nov. 30, 2020

Related U.S. Application Data
(60) Provisional application No. 62/963,232, filed on Jan. 20, 2020.

(51) Int. Cl. G06Q 30/02; G06Q 50/26; G06Q 10/06; G06Q 50/12

(52) U.S. Cl. CPC G06Q 30/0201; G06Q 50/12; G06Q 10/06393; G06Q 50/26

(57) ABSTRACT

Overtourism (overcrowding) occurs when there are too many people/tourists at a certain place, attraction, activity, or event at a particular time exceeding the capacity. Determining an overtourism score for an entity such as a place, attraction, activity, or event and benchmarking that score includes the collection of one or more types of data associated with a specific entity, its visitors, demographics, weather, and other relevant information.

### FIELD OF INVENTION

This disclosure generally relates to tourism information. More specifically, this disclosure relates to calculating the overtourism score and benchmarking of an entity such as a place, attraction, activity, event, etc.

### BACKGROUND OF THE INVENTION

Overtourism (overcrowding) occurs when there are too many people/tourists at a certain place, attraction, activity, or event at a particular time, exceeding the capacity. The focus of the travel industry is exclusively on its growth, with little or no concern for its impacts. After years of growth, tourism has created more problems than benefits in many areas. Whether it's millions of tourists in a large city or only a handful of tourists in a small town, overtourism has caused a lot of problems for the residents of an area or region. Narrow roads get jammed with tourist traffic. Overtourism has also been recorded in national parks and other wildlife areas. Wildlife is in danger and running away as tourists are entering into their habitat. It has become unmanageable to handle and control the overtourism and its negative impacts. As a result, overtourism is receiving more attention today than it did in the past. Due to tourism's negative impacts, some previously well-known tourist places have been abandoned by tourists. Undertourism occurs when there are insufficient amounts of people/tourists visiting the entities not meeting the capacity, for example, post-Olympics tourism decline.

### SUMMARY OF THE INVENTION

The purpose of the present invention is to provide an overtourism score for an entity such as a place, attraction, activity, or event using the associated data. An entity will be assessed for overtourism and its impacts. Based on the assessment, tourists, local residents, governments, tourist boards, and other management teams can make important decisions to manage the overtourism of an entity, improve the overall experience, and reduce the negative impacts of overtourism.

To reduce overtourism, an entity can benchmark its overtourism performance score against similar entities to make sure it's overtourism score is not above the standard average (written or unwritten). In doing so, authorities can make decisions to reduce the probability of experiencing overtourism and reduce the probability of suffering from infrastructure, economic, social, political, environmental, and/or exposure to other negative impacts.

Embodiments include calculating an overtourism score of the entity for at least one of the one or more types of tourism data. This is based on the processing of an entity's visitor/tourist information that is extracted from at least one type of data, where an entity and visitor/tourist information indicates a level of overtourism.

### BRIEF DESCRIPTION OF DRAWINGS

FIG. 1 shows a flow diagram of functions performed by a system for calculating and benchmarking an entity's overtourism score in one embodiment of the present invention; and

FIG. 2 is a flow diagram of a method for calculating and benchmarking an entity's overtourism score according to an embodiment, and

FIG. 3 is a block diagram of a network that includes a scorecard engine, notifications engine, data sources, and an entity with overtourism according to an embodiment; and

FIG. 4 is a block diagram of a system for calculating and benchmarking an entity's overtourism score according to an embodiment; and

FIG. 5 is a block diagram of an interactive dashboard displayed by the scorecard system according to an embodiment.

### DETAILED DESCRIPTION OF INVENTION

The overtourism score of an entity may serve as critical information used to guide tourism, improve tourism experience, and other decisions. To provide a clear and accurate picture of an entity's overtourism, the concepts described here involve identifying and collecting the data associated with an entity. All data of an entity will be collected from external and internal data sources using various data collection methods.

The collected data is further contextualized to identify meaningful data to accurately calculate the overtourism score. To provide the context, the collected data is processed using extraction, parsing, filtering, aggregation, and/or other methods and also excludes irrelevant data from consideration. To calculate an overtourism score, the contextualized data is used. The score further can be normalized and/or weighted using one or multiple factors such as the capacity of an entity, type of data collected, and the relationship between the collected data.

The scorecard system can be used to benchmark the calculated overtourism score. The scorecard system can use the calculated overtourism score to determine ranking, percentile, and other detailed overtourism information about the entity, and compare various overtourism metrics relating to the entity to those of its competitors, current and prospective entities. An entity may use such benchmark information to manage its overtourism score and to guide the visitors, tourists, governments, tourist boards, event management, etc.

As discussed further, the inventive concepts allow the overtourism score for an entity to be updated via real-time monitoring. The scorecard system allows the overtourism score to be calculated nearly instantly, or in near real-time. As a result, the scorecard system can be used by an entity to track its historical scores and be proactive in alerting overtourism. The scorecard system can be used by an entity to reduce overtourism by controlling the visitors, providing excellent service, and by getting near-instant scores. The Scorecard system will generate alerts, notifications, issues, and recommendations which can be subscribed by the users of the system.

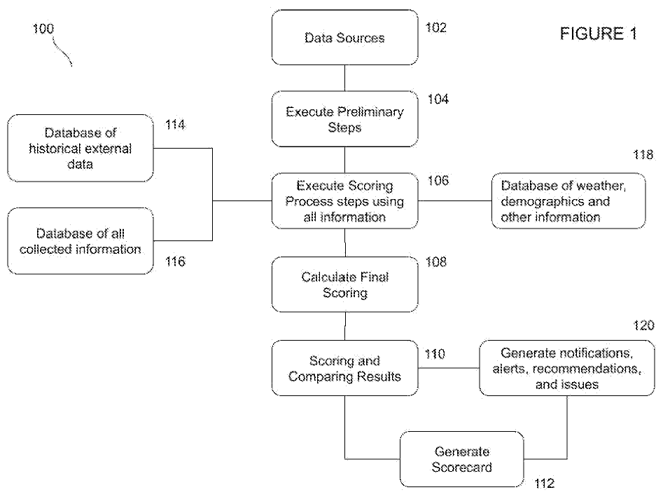

FIG. 1 is a flow diagram of functions performed by a scorecard system. The data can be collected from various data sources at block 102. At block 104, the scorecard system can perform preliminary steps, which comprises collecting data associated with an entity. At block 106, the scorecard system comprises executing the scoring process, which comprises executing the contextualization process of the scorecard system. The contextualization/attribution comprises determining whether the collected data 114 & 116 is associated with an entity. Data determined to be associated with an entity can be attributed to the entity, stored in a database 114, 116 & 118 of collected and attributed data for the entity, and contextualized with respect to the entity at block 106. At block 108, the scorecard system may use a benchmarking module to calculate an overall overtourism score for an entity. The scoring results can be produced at block 110 and scorecards will be generated at block 112. In some embodiments, the scorecard system may generate alerts, notifications, issues, and recommendations for an entity at block 120 which can be subscribed by the users of the system. The system also comprises generating an alert when the overall overtourism score exceeds an overtourism threshold.

In some embodiments, the calculated overtourism score, either numeric, letter, or percentile, can be used by governments, tourist boards, or event management to handle and enrich the experience of visitors or tourists. In other words, the scorecard system can be used as an overtourism controlling system. For example, historical overtourism scores calculated using a scorecard system can be used by governments or tourist boards to assess the environmental, social, or economic impacts caused due to overtourism. The governments may then plan developmental projects based on the assessment of environmental, social, or economic impacts.

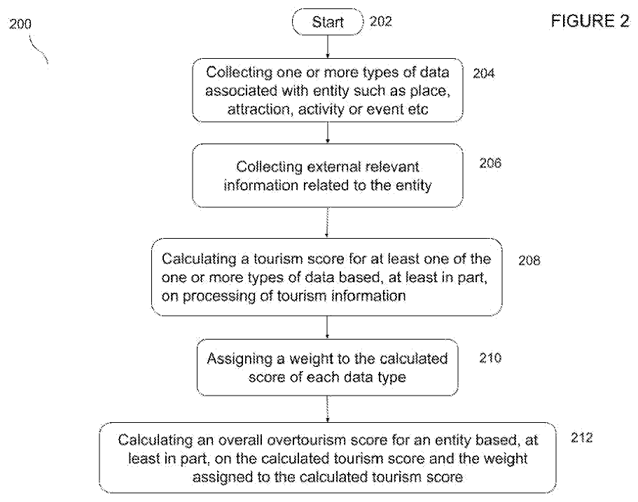

FIG. 2 is a flow diagram of a method for determining an entity's overtourism score according to an embodiment. At block 204 and 206, all types of data of an entity and its all relevant information will be collected from various sources and further used to calculate the overtourism score. At block 208, a tourism score will be calculated for at least one or more types of data collected in previous steps. A specific weight will be assigned to the calculated tourism score of each data type at block 210. At block 212, an overall overtourism score for an entity will be based on the calculated tourism score of each data type 208 and the weight assigned to the calculated tourism score 210.

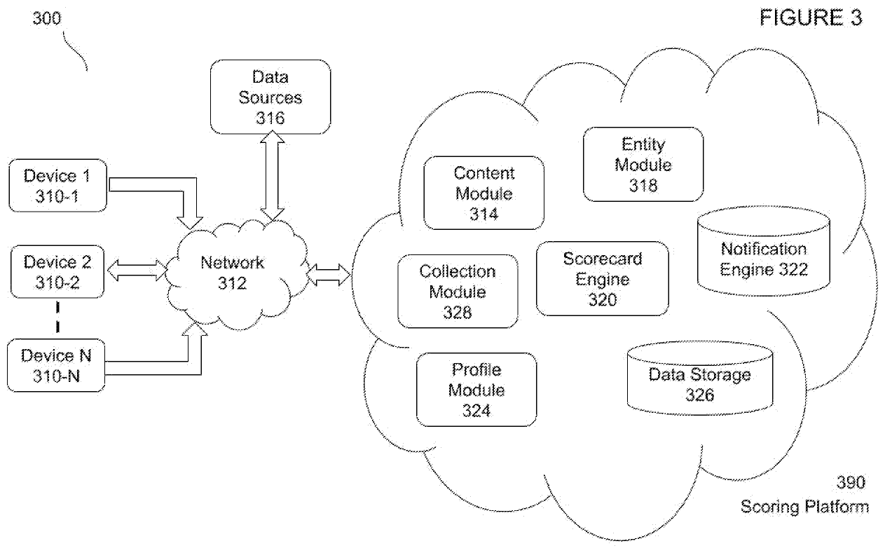

In FIG. 3, the system 300 includes the network-based scoring platform 390 which comprises the content module 314, data sources 316, entity module 318, scorecard engine 320, notification engine 322, profile module 324, data storage 326, collection module 328, and user devices 310-1, 310-2, . . . , 310-N. These modules are configured to perform several functions described below.

As shown in FIG. 3, the scoring platform 390 uses the overtourism scoring engine 320 to calculate the overtourism score of entities in entity module 318 using data collected from data sources 316 and/or data storage 326. Content module 314 may serve as a portal by which a user may access a scorecard system described below. The content module 314 can allow multiple users to interface with each other, inside and outside system 300.

The collection module 328 accesses entity module 318, data sources 316, and/or data storage 326 to collect further information required to calculate and benchmark an entity's overtourism score. The entity module 318 stores and provides data information of an entity such as place, attraction, activity, or event. For example, and not limitation, one entity may be an attraction in Machu Picchu, while another entity may be a group of one or more attractions such as Orlando City.

Data sources 316 includes any source of data, for example, and not limitation, one source of data can include a website associated with an entity, while another source of data may be an online database containing various information. In general, the data sources 316 may be sources of any kind of data, such as geographical data, environmental data, tourist data, public health data, hotel/flight data, restaurant data, traffic data, political data, government data, etc. Data sources 316 are not limited to a particular data source, and any other source from which data may be collected may serve as a data source for the system.

The users of the system can subscribe to alerts or event-based notifications through notification engine 322. Users can choose whether they want alerts delivered through email, SMS, Push notifications, or any other methods. Users may also subscribe to alerts for selected events or selected entities.

Profile module 324 stores and updates user profiles for accounts associated with user devices 310-N. The user profiles may include various information regarding a user, for example, types of services the user has subscribed to, a list of media content recently stored/retrieved by the user, ratings of media content by the end-user, user device unique identifiers, application identifiers of the application showing the media content, etc.

Data storage 326 may include one or more devices that receive and maintain data retrieved or uploaded from data sources 316 and user devices 310. Data storage 326 may store, for example, media content that may be accessed by another device, such as entity module 318. Data storage may store all relevant and historical information such as geographical data, environmental data, tourist data, public health data, hotel/flight data, restaurant data, traffic data, political data, government data, etc.

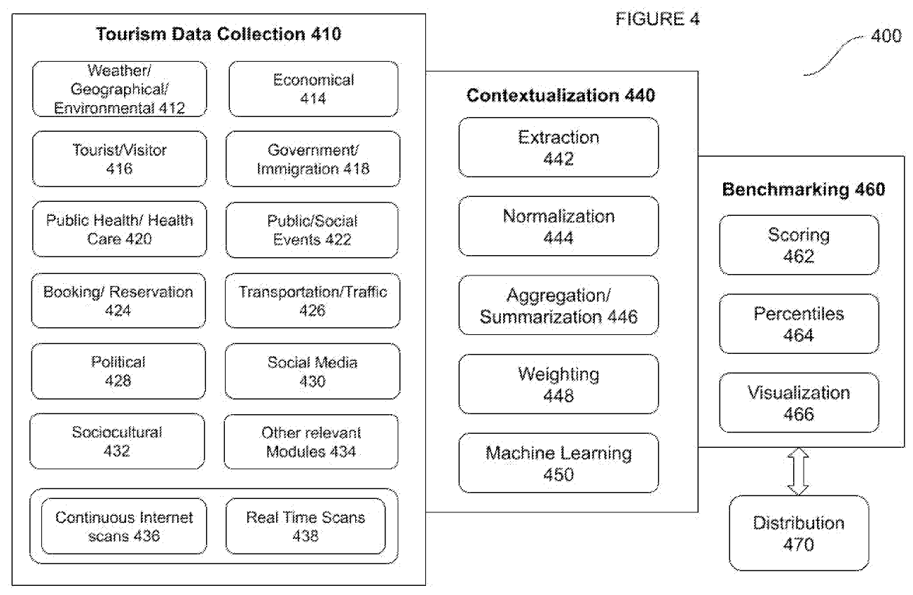

FIG. 4 is a diagram of a system used for calculating and benchmarking an entity's overtourism score. System 400 can be implemented within the modules such as scorecard engine 320, collection module 328, etc described in FIG. 3. System 400 comprises a tourism data collection module 410, a contextualization module 440, and a benchmarking module 460.

Tourism data collection module 410 collects one or more types of data that are related to overtourism associated with an entity. Tourism data collection module 410 comprises submodules that collect different types of data from a predefined data collector. The data collector includes sources of information that likely correspond to the data indicative of an entity's overtourism score. Each submodule as part of module 410 collects the types of data from several channels or data feeds from internal and various external data sources.

According to the illustrated embodiment, tourism data collection module 410 comprises a weather/geographical/environmental module 412, economical module 414, tourist/visitor module 416, government/immigration module 418, public health/health care module 420, public/social events module 422, booking/reservation module 424, transport/traffic module 426, political module 428, social media module 430, sociocultural module 432, other relevant modules 434, continuous internet scans 436, and real-time scans module 438.

Tourism data collection module 410 also comprises submodules for specifying when data is collected and how data is associated with an entity. Submodules perform data collection using different collection methods such as data pulls, surveys, data feeds, frequent scans, etc. Continuous internet scans submodule 436 performs frequently scheduled scans on Internet data to collect tourism data associated with an entity. Another submodule, the real-time scans module 438 collects data in real-time, such as the current temperature in Orlando City. The other submodules collect data specific to an entity by using various collection methods such as data pull from other sources, subscription to other data sources, etc. on a frequent basis.

Contextualization module 440 contextualizes data collected by the tourism data collection module 410. The contextualization module 440 comprises an extraction submodule 442 which extracts tourism data of a given entity from the collected data. The contextualization module 440 can also comprise a normalization submodule 444, aggregation/summarization submodule 446, and a weighting submodule 448 to normalize and/or weight a preliminary overtourism score determined based on a raw scoring of the extracted tourism data. The normalization and/or weighting of a preliminary tourism score may depend on multiple factors, such as, for example, the type of data collected and the population of an entity.

The contextualization module 440 can also comprise a machine learning submodule 450 to identify and update which factors most significantly affect an entity's overtourism. Contextualization module will exclude irrelevant data collected to reduce the amount of data and improve the overall performance. Machine learning submodule 450 will learn from the data collected from various sources and identify relevant factors for calculation. Those factors and other relevant information can be used to further contextualize collected information. For example, the overtourism scores identified as being the most relevant for an entity may then be normalized and/or weighted to the entity for its relevance. The contextualization process can also comprise applying temporal adjustments to collected tourism data or calculated scores based on time spans and its relevance.

Benchmarking module 460 calculates an overall overtourism score for an entity, as well as a benchmark based on tourism metrics. The computed benchmark may further comprise a percentile ranking for the entity. For example, the benchmarking module 460 comprises a scoring module 462 which uses the contextualization of the entity's tourism data and scores for each different type of tourism data to obtain the overall overtourism score for an entity. The percentile submodule 464 can determine a percentile ranking for the entity by comparing various attributes of entities with other entities in the same region or other regions. Benchmarking module 460 also comprises a visualization submodule 466 which creates a comparative visualization of overtourism scores calculated and benchmarked in earlier submodules.

The scorecard engine 320 in FIG. 3 can utilize one or more submodules from tourism data collection 410, contextualization 440, and benchmarking 460 modules for calculating and benchmarking the overtourism score of an entity. Computing and benchmarking an entity's overtourism score can be initiated when the scorecard engine 320 in FIG. 3 obtains a uniform entity identifier (UEI) associated with an entity to calculate and benchmark an entity's overtourism score. For example, by entering a UEI associated with an entity for which overtourism is being assessed, a user may access the scorecard system 400 via a user interface that communicates with the scorecard engine 320 in FIG. 3. In some embodiments, an identity of the entity comprises a set of attributes such as the name of the entity, etc. This first set of attributes may also comprise necessary attributes used to define an entity, such as, for example, the location of the entity, and the identity of one or more of the entity's competitors. These necessary attributes are required in the definition of the entity.

In some embodiments, the scorecard system 400 can provide access credentials required to access restricted parts of the overtourism content module 314. In such embodiments, receiving, for example, access to a request to calculate an entity's overtourism score via overtourism content module 314 may be determined by profile module 324 providing the access credentials.

In response to receiving a request to calculate an entity's overtourism score, the scorecard system 400 identifies data points associated with the entity. Data points correspond to data sources that are likely to contain data relevant to the entity's overtourism score. In other words, the scorecard system 400 can identify one or more data sources from which to collect one or more types of data relating to the entity's overtourism based on the first set of attributes the scorecard system 400 received via the content module 314. For example, the scorecard system 400 may identify weather/geographical data and/or public health data associated with the entity as data points.

Once the scorecard system 400 identifies data points and sources of general or supplemental data for the entity, tourism data collection module 410 collects different types of data associated with the entity from the identified data points and sources. The different types of data collected by tourism data collection module 410 can be collected using various methods such as observation, collection of individual data (surveys, interviews, questionnaires, etc.), collection of statistical data, and internet statistics/web analytics, etc.

One type of data associated with an entity that can be collected is social media information using social media collection module 430. Social media information includes any information which can provide travel experience and other relevant data to indicate overtourism. Social media information can also be collected by responses to tourist surveys, as well as tourist ratings, reviews, feedback, social networking websites, etc. This information can also be collected from vendors that collect tourist surveys, reviews, or feedback, etc. Also, collecting social media information can comprise collecting data that provides an indication of the number of people and service providers that work for an entity. Collecting social media information can also comprise collecting information on social media sites provided by tourists, service providers, operators, etc.

Another type of data the scorecard system may collect is information about weather, the environment, and other geographic data using weather/geographical collection module 412. To collect information, scorecard system 400 may search the Internet for climate variability that brings unusual or extreme weather, such as, for example, heatwaves, drought, floods, etc. When the scorecard system 400 calculates the overtourism score, it bases it on several critical factors, both positive and negative. Positive factors such as coral reefs, wildlife, etc. attract tourists while negative factors such as heatwaves, diseases, etc. negatively affect tourism.

Economical collection module 414 collects the relevant information about product/service demand, overall sales, income, jobs, taxes, etc in the region due to tourism activity. Scorecard system 400 may collect information about supply availability, product sustainability, visitor spending surveys, quality measures, forecasting, government economic statistics, etc. Scorecard system 400 can also collect information about the usage of local resources such as transportation, electricity, water, etc.

Another type of data that can be collected is information about visitors, including information about visitor numbers, flows, preferences, expenditure, activities, etc. using tourist/visitor collection module 416. Visitor collection module 416 may include specifics about a visitor such as their gender, age, income, area of residence, etc. as well as who they are traveling with, bookings, activities, experiences, merchandise purchased, food preferences, etc. To collect information, scorecard system 400 may collect a visitor's details such as where the visitor has traveled from, their interests, their feedback, etc. Scorecard system 400 may also create a user profile using profile module 324.

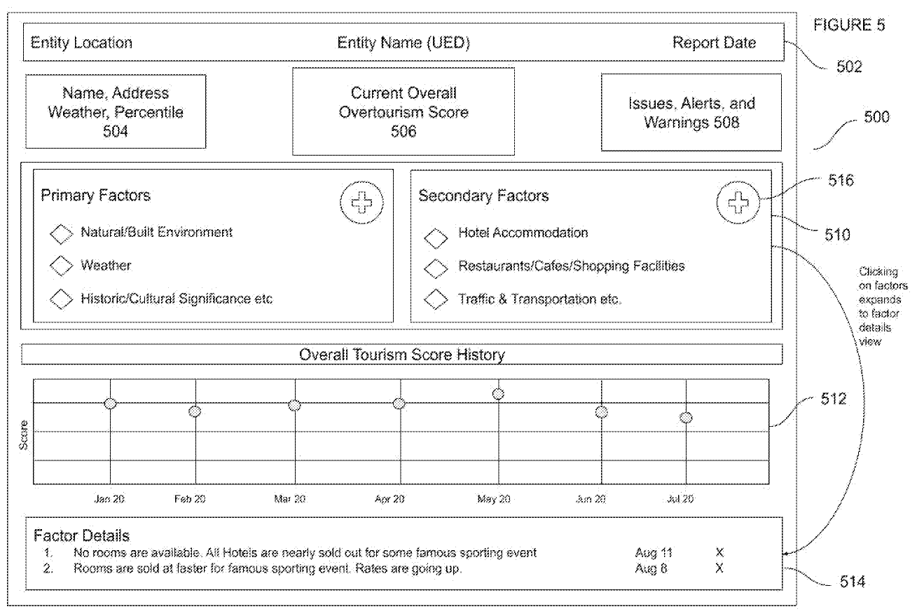

FIG. 5 is an illustration of the scorecard dashboard created using the data outputted by the scorecard system 400. The dashboard comprises the title bar 502, entity identification 504, the current overall overtourism score 506, a number of issues, alerts and warnings 508, primary and secondary factors affecting the overall overtourism score 510, a graph showing historically by month the entity's overall overtourism score 512, as well as extra details for the primary and secondary factors 514. Primary factors are factors with a larger effect on the overall overtourism score 506, while secondary factors have a smaller effect on the overall overtourism score 506. With the use of add/remove factors 516, a dashboard user has the ability to choose specific factors which they want to display on the screen, and which ones they want to remove from the screen. A dashboard user may click on primary and secondary factors 510 to view factor details 514 for information on each of the factors mentioned in primary and secondary factors 510. The overall overtourism score 506 has been categorized into several categories with color-coding such as highly overtourism (Red), slightly overtourism (Yellow), no overtourism (Green), and undertourism (Light Blue). The overall overtourism score on the dashboard has been shown with appropriate category color background.

The invention claimed is:

1. A method for determining an entity's overtourism score, the method comprising:
obtaining information identifying the entity and one or more types of data corresponding to the tourism of the entity;
in response to obtaining information, calculating an overtourism score of the entity where the overtourism score represents the tourism situation of the entity.

2. The method of claim 1, further comprising determining a tourism percentile ranking for the entity using benchmarking of the overtourism score by comparing overtourism score for one or more entities in the same region or across the region.

3. The method of claim 1, further comprising generating recommendations, issues, alerts, and notifications based upon changes in overtourism score or primary/secondary factors, or overtourism score has significant differences in comparison with other similar entities in the same region or across the region.

4. The method of claim 3, further comprising monitoring of data associated and overtourism score based upon alerts generated by real-time scanning of tourism data.

5. The method of claim 1, further comprising normalizing the overtourism score based on one or more types of tourism data, type of entity, size of the entity, and specific conditions of the entity.

6. The method of claim 1, further comprising generating an interactive scorecard of overtourism score for the entity including score history, issues and alerts, all primary and secondary factors, and details of these factors impacting the overall score. The method also includes the presentation of the scorecard to the end user via an interactive user interface.

7. The method of claim 1, further comprising processing of one or more types of data such as weather, environmental, tourist, demographics, public health, economical, accommodation, transportation, sociocultural, political, religious, events, tourist experience, and all other tourism information about the entity to calculate overall tourism score. The method also comprises all historical information for types of data related to the entity.
